(19) United States
(12) Patent Application Publication
(10) Pub. No.: US 2017/0206566 A1
(43) Pub. Date: Jul. 20, 2017

(54) MARKETING SYSTEM ALLOWING MULTIPLE SALES TERMINALS TO MARKET PRODUCTS REGISTERED BY ONE ANOTHER

(71) Applicant: Hsien-Ta Chao, Taipei City (TW)

(72) Inventor: Hsien-Ta Chao, Taipei City (TW)

(21) Appl. No.: 14/997,580

(22) Filed: Jan. 18, 2016

(51) Int. Cl. G06Q 30/02

(52) U.S. Cl. CPC G06Q 30/0276; G06Q 30/0277

(57) ABSTRACT

A marketing system includes a host, a first sales terminal and a second first sales terminal. The first sales terminal is linked to the host and used for registering a first set of products to the host and marketing the first set of products. The second sales terminal is linked to the host and used for registering a second set of products to the host and marketing the second set of products. The second sales terminal markets the first set of products only when the first sales terminal markets the second set of products.

### BACKGROUND OF THE INVENTION

1. Field of the Invention

The present invention relates to a marketing system, and more particularly, a marketing system allowing multiple sales terminals to market products registered by one another.

2. Description of the Prior Art

Unlike conventional sales model relying on physical stores, it has been a common and convenient way for consumers and retailers to place purchase orders via internet. However, for product providers such as manufacturers or vendors, it is a challenge to market products. The following marketing approaches are widely used presently: participating in trade shows to exhibit products on booths, buying advertisements shown on traditional media (e.g. magazine and television) or internet media (e.g. social network websites such as Facebook, Twitter, etc.), putting products onto a large electronic retail website (e.g. Amazon, e-bay) and paying for better search ranking, or building a self-owned online store for customers to visit and make purchases. However, each of the foresaid marketing approaches would lead to shortcomings such as high marketing expense and limited product visibility because the product information may be hardly seen from the huge amount of analogous information on internet. The conversion rate of receiving purchase order is difficult to be estimated or even under expectation. Moreover, from seeing a traditional advertisement to buying a product, the operation complexity for a consumer is so high that the probability of successfully completing a purchase is decreased. Hence, a solution for improving the marketing effect is necessary in the field.

### SUMMARY OF THE INVENTION

An embodiment of the present invention discloses a marketing system including a host, a first sales terminal and a second first sales terminal. The first sales terminal is linked to the host and used for registering a first set of products to the host and marketing the first set of products. The second sales terminal is linked to the host and used for registering a second set of products to the host and marketing the second set of products. The second sales terminal markets the first set of products only when the first sales terminal markets the second set of products.

Another embodiment of the present invention discloses a marketing method. The marketing method includes linking a first sales terminal to a host; the first sales terminal registering a first set of products to the host; linking a second sales terminal to the host; the second sales terminal registering a second set of products to the host; the first sales terminal marketing the first set of products and the second set of products; and the second sales terminal marketing the first set of products only when the first sales terminal markets the second set of products, and marketing the second set of products.

Yet another embodiment of the present invention discloses a marketing method. The marketing method includes linking a first sales terminal to a host; the first sales terminal registering a first set of products to the host; linking a second sales terminal to the host; the second sales terminal registering a second set of products to the host; the first sales terminal marketing the first set of products and advertising the second set of products; and the second sales terminal advertising the first set of products only when the first sales terminal advertises the second set of products, and marketing the second set of products.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a marketing system according to an embodiment of the present invention.

FIG. 2 illustrates an operation condition of a part of the marketing system of FIG. 1.

FIG. 3 illustrates another operation condition of the part of marketing system shown in FIG. 2.

FIG. 4 illustrates a flowchart of a marketing method according to an embodiment of the present invention.

FIG. 5 illustrates a flowchart of steps further included by the marketing method according to another embodiment of the present invention.

FIG. 6 illustrates a flowchart of steps further included by the marketing method according to yet another embodiment of the present invention.

FIG. 7 illustrates a condition as an example for describing category selection according to an embodiment of the present invention.

FIG. 8 illustrates a flowchart of steps further included by of the marketing method according to yet another embodiment of the present invention.

FIG. 9 illustrates the interaction between a customer and the marketing system according to an embodiment related to FIG. 8.

FIG. 10 illustrates a flowchart of a marketing method according to another embodiment of the present invention.

FIG. 11 illustrates a mutual advertising operation corresponding to the marketing method of FIG. 10.

### DETAILED DESCRIPTION

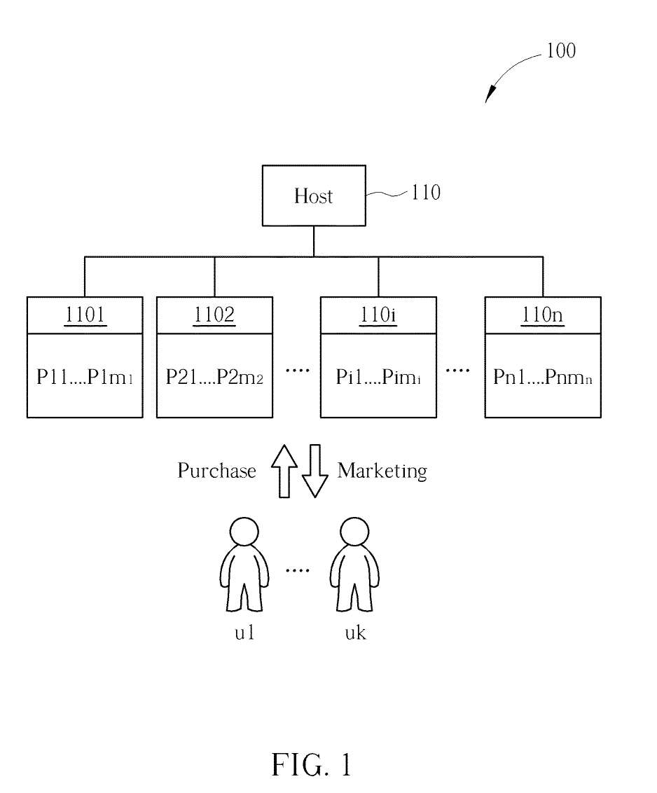

FIG. 1 illustrates a marketing system 100 according to an embodiment of the present invention. The marketing system 100 may include a host 110 and a plurality of sales terminals 1101 to 110n linked to the host 110 via wired and/or wireless communication paths. Each of the sales terminals 1101 to 110n may be operated by a product manufacturer or a vendor who provides a particular set of products on the sales terminal. It may be as shown in FIG. 1 and table 1:

TABLE 1

| sales | Products registered by the corresponding sales |
|---|---|
| terminal | terminal |
| 1101 | P11 . . . P1m₁ |
| | (m₁ kinds of products registered with the host 110 |
| | by the sales terminal 1101) |
| 1102 | P21 . . . P2m₂ |
| | (m₂ kinds of products registered with the host 110 |
| | by the sales terminal 1102) |
| . . . | . . . |
| 110i | Pi1 . . . Pimᵢ |
| | (mᵢ kinds of products registered with the host 110 |
| | by the sales terminal 110i) |
| . . . | . . . |
| 110n | Pn1 . . . Pnmₙ |
| | (mₙ kinds of products registered with the host 110 |
| | by the sales terminal 110n) |

For example, the sales terminal 1101 may correspond to an automobile parts manufacturer who operates the sales terminal 1101, and the products P11 to P1m₁ may be m₁ kinds of products manufactured by the sales terminal 1101. For another example, the sales terminal 110i may be a bicycle manufacturer, the products Pi1 to Pimᵢ may be mᵢ kinds of products related to bicycle and manufactured by the sales terminal 110i. Hence, each sales terminal may provide a particular set of products. Each of the abovementioned parameters i, n, m₁, m₂, mᵢ and mₙ is a positive integer larger than zero. The host 110 may be an administrator terminal of the marketing system 100 and may be a server equipped with necessary control devices, storage devices, databases and control programs. The verb “market” in the text may mean offering a product to a market for potential customers (e.g. the customer u1 to uk).

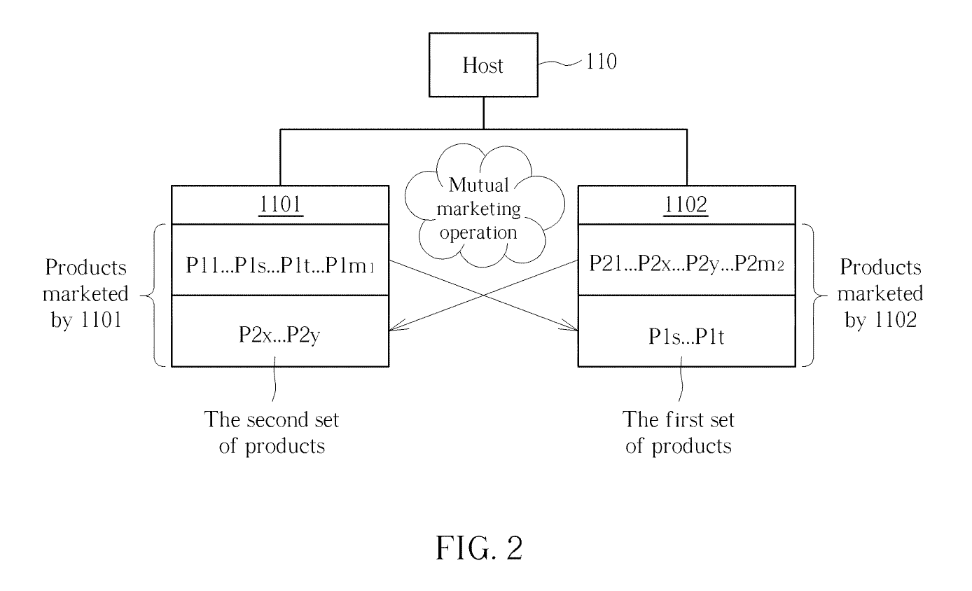

FIG. 2 illustrates an operation condition of a part of the marketing system 100 of FIG. 1. In FIG. 2, the sales terminals 1101 and 1102 of FIG. 1 are taken for example. The sales terminal 1101 may be considered as a first sales terminal, and the sales terminal 1102 may be considered as a second sales terminal. According to an embodiment of the present invention, the first sales terminal 1101 is linked to the host 110 and able to register a plurality of products P11 to P1m₁ to the host 110 and market the plurality of products P11 to P1m₁. The plurality of products P11 to P1m₁ has a first set of products P1s to P1t where 1s and 1t are integers between 1 and m₁. The second sales terminal 1102 is linked to the host 110 and able to register a plurality of products P21 . . . P2m₂ to the host 110 and market the plurality of products P21 . . . P2m₂. The plurality of products P21 to P2m₂ has a second set of products P2x to P2y wherein 2x and 2y are integers between 1 and m₂. The second sales terminal 1102 may market the first set of products P1s to P1t only when the first sales terminal 1101 markets the second set of products P2x to P2y. Hence, the marketing system 100 and multiple other sales terminals may market products registered by one another. The first and second sales terminals may therefore perform a mutual market operation for creating great synergy. Only when the first sales terminal 1101 markets the second set of products (e.g. P2x to P2y) registered by the second sales terminal 1102, the second sales terminal 1102 markets the first set of products (e.g. P1s to P1t) registered by the first sales terminal 1101 and vice versa. In other words, if the sales terminal 1101 does not market products registered by the sales terminal 1102, the products registered by the sales terminal 1101 will not be marketed by the sales terminal 1102, and the mutual marketing scenario will fail to occur. On the other hand, when the sales terminal 1101 markets products registered by other sales terminals 1102 to 110i, the products registered by the sales terminal 1101 will be marketed by other sales terminals 1102 to 110i in addition to the sales terminal 1101, and the mutual marketing scenario will be carried on. The mutual marketing scenario will be encouraged in this way because the owner of each sales terminal would hope his/her products to be widely marketed on the internet. According to embodiments of the present invention, each sales terminal in the marketing system 100 may be a website acting as an individual internet store for marketing thousands or even tens of thousands of products registered by multiple sales terminals (e.g. 1101 to 110n), and each product (e.g. one of P11 to Pnmₙ) may be marketed by thousands sales terminals (e.g. 1101 to 110n), so the product visibility will be greatly improved. Although the first set of products P1s to P1t is illustrated as a subset of the products P11 to P1m₁ (as defined in formula (a1) below), the first set of products P1s to P1t may also be allowed to contain the products P11 to P1m₁ in a boundary condition (as defined in formula (a2) below).

{P1s to P1t}ε{P11 to P1m₁} (a1)

{P1s to P1t}={P11 to P1m₁} (a2)

Similarly, although the first set of products P2x to P2y is illustrated as a subset of the products P21 to P2m₂ (as defined in formula (b1) below), the second set of products P2x to P2y may also be allowed to contain the products P21 to P2m₂ in a boundary condition (as defined in formula (b2) below).

{P2x to P2y}ε{P21 to P2m₂} (b1)

{P2x to P2y}={P21 to P2m₂} (b2)

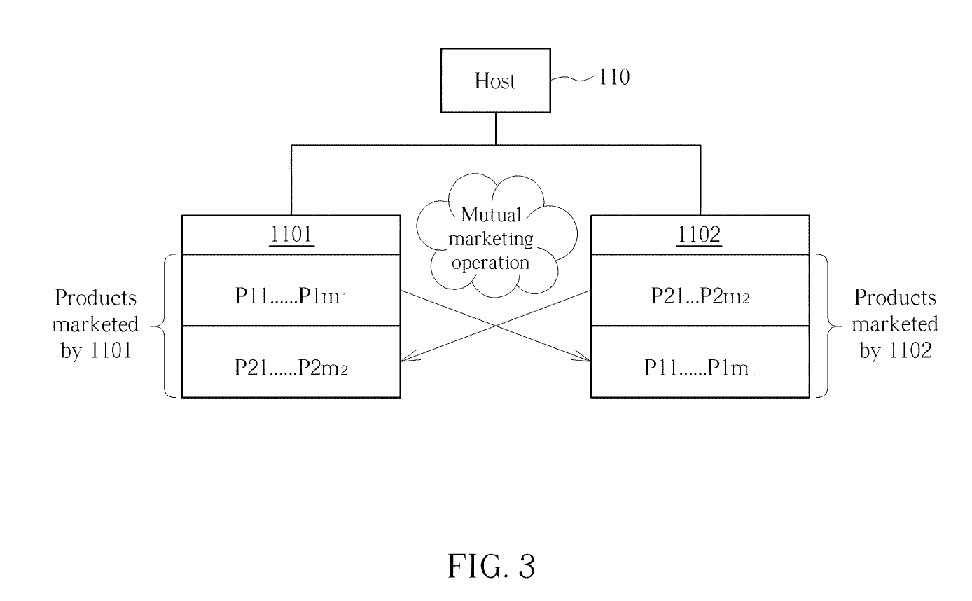

FIG. 3 illustrates another operation condition of the part of marketing system 100 shown in FIG. 2. The embodiment shown in FIG. 3 is corresponding to the foresaid boundary conditions of the formulae (b1) and (b2). In the case of FIG. 3, the first sales terminal 1101 may market all products (e.g. P21 to P2m₂) registered by the second sales terminal 1102, and the second sales terminal 1102 may market all products (e.g. P11 to P1m₁) registered by the first sales terminal 1101. In FIGS. 2-4, only two sales terminals 1101 and 1102 are taken as an example for explaining the mutual marketing scenario performed according to embodiments of the present invention. However, the number of sales terminals in the marketing system 100 is not limited to two. For example, when there are n sales terminals in total, each sales terminal may market the products registered by its own and products registered by other (n−1) sales terminals. Hence, the synergistic effect of the mutual marketing would be significant.

According to an embodiment of the present invention, potential customers u1 to uk of products marketed by any of the sales terminals 1101 to 110n may have sales permits. Hence, a potential customer may be a legal retailer to purchase a product from the marketing system 100 for resell. The marketing system 100 may therefore be allowed to support b2b (business-to-business) service and supply chain. All trading behaviors should comply with related local/state/federal tax laws and marketing agreements.

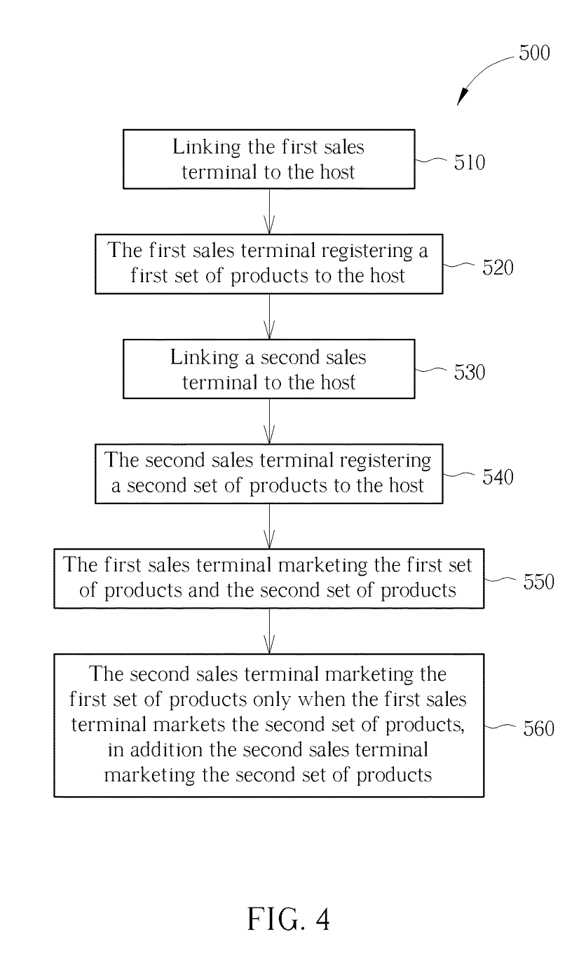

FIG. 4 illustrates a flowchart of a marketing method 500 according to an embodiment of the present invention. FIGS. 1-3 may also be referred when referring to FIG. 4. The marketing method 500 may include:

Step 510: linking the first sales terminal 1101 to the host 110;
Step 520: the first sales terminal 1101 registering a first set of products (e.g. P1s to P1t) to the host 110;
Step 530: linking a second sales terminal 1102 to the host 110;
Step 540: the second sales terminal 1102 registering a second set of products (e.g. P2x to P2y) to the host 110;
Step 550: the first sales terminal 1101 marketing the first set of products (e.g. P1s to P1t) and the second set of products (e.g. P2x to P2y); and
Step 560: the second sales terminal 1102 marketing the first set of products (e.g. P1s to P1t) only when the first sales terminal 1101 markets the second set of products (e.g. P2x to P2y), in addition the second sales terminal 1102 marketing the second set of products (e.g. P2x to P2y).

Since the second sales terminal 1102 markets the first set of products (e.g. P1s to P1t) only when the first sales terminal 1101 markets the second set of products (e.g. P2x to P2y), four conditions can be described in the following table 2. As shown in table 2, the mutual marketing scenario may only be performed when both the first and second sales terminals 1101-1102 agree to market products registered by each other.

TABLE 2

| The first sales | The second sales | |
|---|---|---|
| terminal agrees | terminal agrees | |
| to market the | to market the | |
| second set of | first set of | |
| products? | products? | Result |
| Yes | Yes | The mutual marketing scenario |
| | | is performed. |
| | | Each of the first and second |
| | | sales terminals markets both |
| | | the first and the second sets of |
| | | products. |
| Yes | No | The mutual marketing scenario |
| No | Yes | fails to be performed. |
| No | No | The first sales terminal |
| | | markets the first set of |
| | | products without marketing the |
| | | second set of products, and the |
| | | second sales terminal markets |
| | | the second set of products |
| | | without marketing the first set |
| | | of products. |

The first set of products P1s to P1t may be primary products marketed by the first sales terminal 1101, and the second set of products P2x to P2y may be primary products marketed by the second sales terminal 1102. By implementing mutual marketing strategy, the primary products of the first sales terminal 1101 and the primary products of the second sales terminal 1102 may be marketed to different groups of potential customers if the first sales terminal 1101 and the second sales terminal 1102 have different potential customers, thereby achieving an improved marketing result.

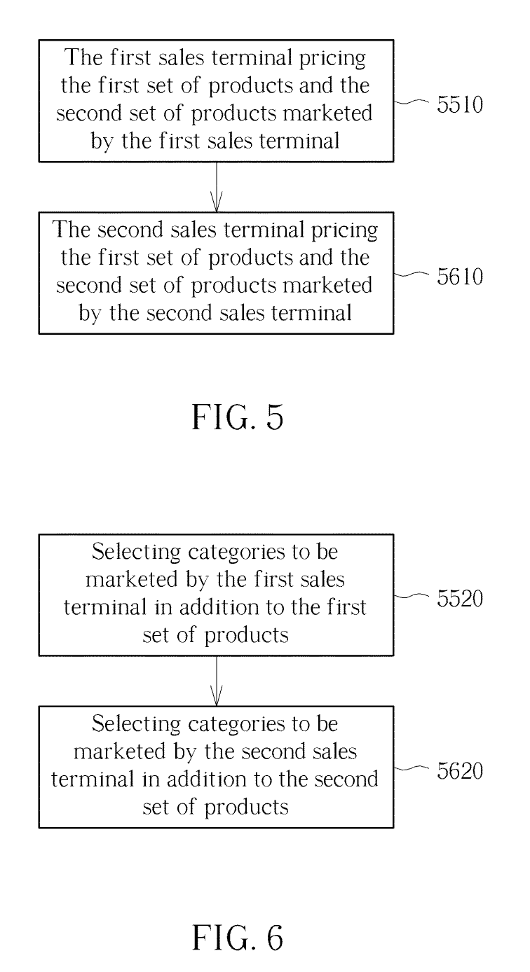

FIG. 5 illustrates a flowchart of steps further included by the marketing method 500 according to another embodiment of the present invention. The marketing method 500 may further include following steps:

Step 5510: the first sales terminal 1101 pricing the first set of products (e.g. P1s to P1t) and the second set of products (e.g. P2x to P2y) marketed by the first sales terminal 1101; and
Step 5610: the second sales terminal 1102 pricing the first set of products (e.g. P1s to P1t) and the second set of products (e.g. P2x to P2y) marketed by the second sales terminal 1102.

Since each sales terminal may act as an individual internet store, even a same product may be marketed by fifty different sales terminals, the fifty sales terminals may price the products at different prices according to different marketing strategies and/or promotion activities.

FIG. 6 illustrates a flowchart of steps further included by the marketing method 500 according to yet another embodiment of the present invention. The marketing method 500 may further include following step:

Step 5520: selecting categories to be marketed by the first sales terminal 1101 in addition to the first set of products (e.g. P1s to P1t).

The second set of products (e.g. P2x to P2y) has to belong to a category selected to be marketed by the first sales terminal 1101 so as to be marketed by the first sales terminal 1101.

For example, if the first sales terminal 1101 is owned by an automobile part manufacturer, the marketing team of the first sales terminal 1101 may like to perform mutual marketing operation with other sales terminals of the categories related to automobile electronics and automobile interior. However, the first sales terminal 1101 may not plan to perform any mutual marketing operation with sales terminals of categories related to cosmetic or bakery material. Hence, it is allowed to select the categories to be marketed by the first sales terminal 1101 in addition to the plurality of products P11 to P1m₁. When selecting the categories to be marketed/not marketed, a table like table 3 may be used. After receiving category selection information (e.g. table 3) from the first sales terminal 1101, the marketing system 100 may arrange the first sales terminal 1101 to market products of the selected categories without marketing the products of the non-selected categories, and a third sales terminal having no products belonging to the categories selected by the first sales terminal 1101 may not market the products registered by the first sales terminal 1101.

TABLE 3

| To be marketed? | Category |
|---|---|
| YES | Automobile parts |
| YES | automobile electronics |
| YES | Automobile interior |
| . . . | . . . |
| NO | Bakery material |
| NO | Cosmetics |
| . . . | . . . |

Table 3 is only a concept table for explaining the concept of category selection performed according to an embodiment of the present invention, but does not represent a real selecting table or program code. In addition to category selection table, other means to select categories (e.g. setting keywords or referring to scores/result of recommending for filtering data of categories in a database) are within the scope of the present invention.

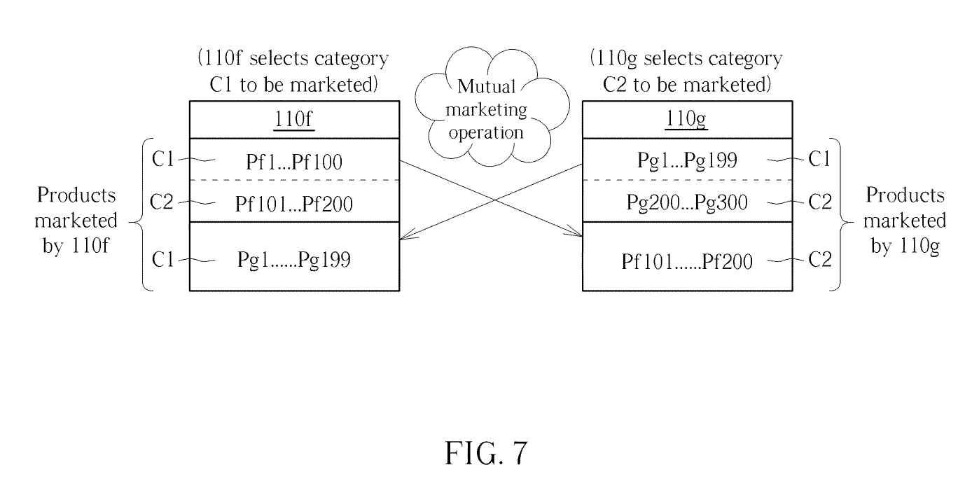

FIG. 7 illustrates a condition as an example for describing category selection according to an embodiment of the present invention. A sales terminal 110f registers products Pf1 to Pf200, and a sales terminal 110g registers products Pg1 to Pg300. The products Pf1 to Pf100 and Pg1 to Pg199 belong to a category C1, and the products Pf101 to Pf200 and Pg200 to Pg300 belong to a category C2. When the sales terminal 110f selects the category C1 to be marketed in additional to its own products (i.e. Pf1 to Pf100), and the sales terminal 110g selects the category C2 to be marketed in additional to its own products (i.e. Pg1 to Pg300), the sales terminal 110f may additionally market products Pg1 to Pg199 (belonging to the category C1), and the sales terminal 110g may additionally market products Pf101 to Pf200 (belonging to the category C2) to implement the mutual marketing scenario. If the sales terminal 110f selects the category C1 to be marketed in additional to its own products (i.e. Pf1 to Pf100), but the sales terminal 110g does not select any of the categories C1 and C2 to be marketed in additional to its own products (i.e. Pg1 to Pg300), then since the sales terminal 110g will not market any of the sales terminal 110f's product, the sales terminal 110f will not market any of the sales terminal 110g's product though the sales terminal 110g has products Pg1 to Pg199 belonging to the category C1 selected by the sales terminal 110f.

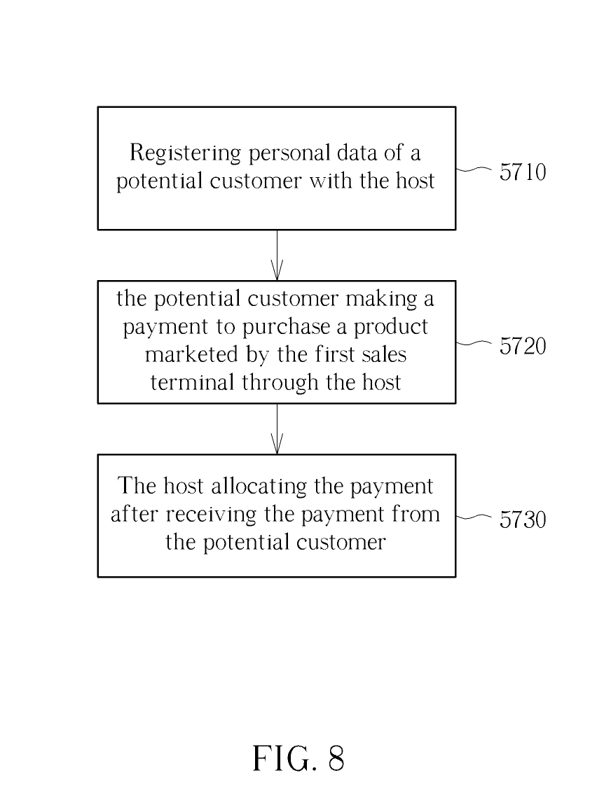

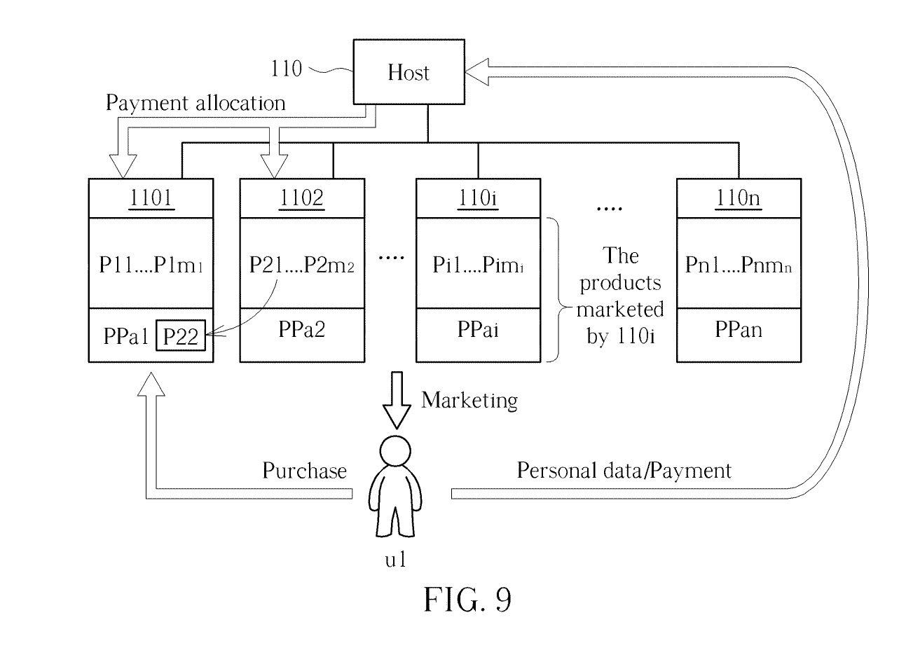

FIG. 8 illustrates a flowchart of steps further included by of the marketing method 500 according to yet another embodiment of the present invention. FIG. 9 illustrates the interaction between a potential customer u1 and the marketing system 100 according to an embodiment related to FIG. 8. The marketing method 500 may further include following steps:

Step 5710: registering personal data of a potential customer u1 with the host 110;
Step 5720: the potential customer u1 making a payment to purchase a product (e.g. a product of P11 to P1m1 and PPa1) marketed by the first sales terminal 1101 through the host 110; and
Step 5730: the host 110 allocating the payment after receiving the payment from the potential customer u1.

The description about some reference signs in FIG. 9 is given first. In FIG. 9, taking the sales terminal 110i for example, a set of products PPai may represent the products marketed by the sales terminal 110i but registered by other sales terminals instead of the sales terminal 110i (i may be one of the positive integers 1 to n). Similarly, each of the sets of products PPa1 to PPan is marketed by a sales terminal which does not register it so as to perform mutual marketing operation. As shown in FIG. 8, the personal data (e.g. email address, credit card number, delivery address, phone number) of the potential customer u1 may be registered with the host 110 so that the host 110 may build a corresponding database. When purchasing a product from the marketing system 110, the potential customer u1 may make a payment through the host 110. The host 110 may allocate the payment after receiving the payment from the potential customer u1. For example, the host 110 may allocate the payment to the first sales terminal 1101 and the second sales terminal 1102 when the potential customer u1 purchases a product P22 (which is of PPa1) registered by the second sales terminal 1102 via the first sales terminal 1101. Since both the sales terminals 1101 and 1102 make contributions to the transaction, the host 110 may allocate the payment to the two the sales terminals 1101 and 1102 according to rules agreed in advance. When registering personal data and/or making a payment, a customer may use an interface corresponding to the host 110, and the same interface is used no matter the customer visits which sales terminal. According to another embodiment, a customized interface may be designed for each sales terminal so as to improve the impression of each sales terminal.

According to yet another embodiment of the present invention, each of the sales terminals (e.g. 1101 to 110n) may sign a corresponding marketing agreement with the host 110. That is, the owner of each sales terminal can sign a corresponding marketing agreement with the owner of the host 110. Each of the two sides signing the marketing agreement may be a natural person or a juridical person (e.g. a company). The signed marketing agreement should comply with related local/state/federal laws.

Since each of the sales terminals 1101 to 110n may be an e-commerce website acting as an on-line store, a shopping cart of the sales terminal 110i may be utilized to purchase a product marketed by the sales terminal 110i. The sales terminal 110i may represent any of the sales terminals 1101 to 110n.

According to an embodiment of the present invention, product information of a product at the sales terminals 1101 to 110n may be updated concurrently. For example, if the first sales terminals 1101 have registered two thousand automobile taillights with the host 110, and sales terminals 1102 to 110n are performing mutual marketing operation to market the automobile taillight, when one of the two thousand automobile taillights is purchased, the product information may be concurrently updated so that the available number of automobile taillights may become one thousand, nine hundred and ninety-nine at all of the sales terminals 1101 to 110n.

According to another embodiment of the present invention, a product may be stored in a vicinity of target customers of the product. For example, if the first set of products (e.g. P1s to P1t) are merchandise related to American football, the first set of products may be stored near major cities with high population in the United States to be in the vicinity of the target customers who may be the retailers reselling the merchandise to fans of Super Bowl. The delivery time may therefore be reduced. The target customers may have sales permits since they should be registered retailers.

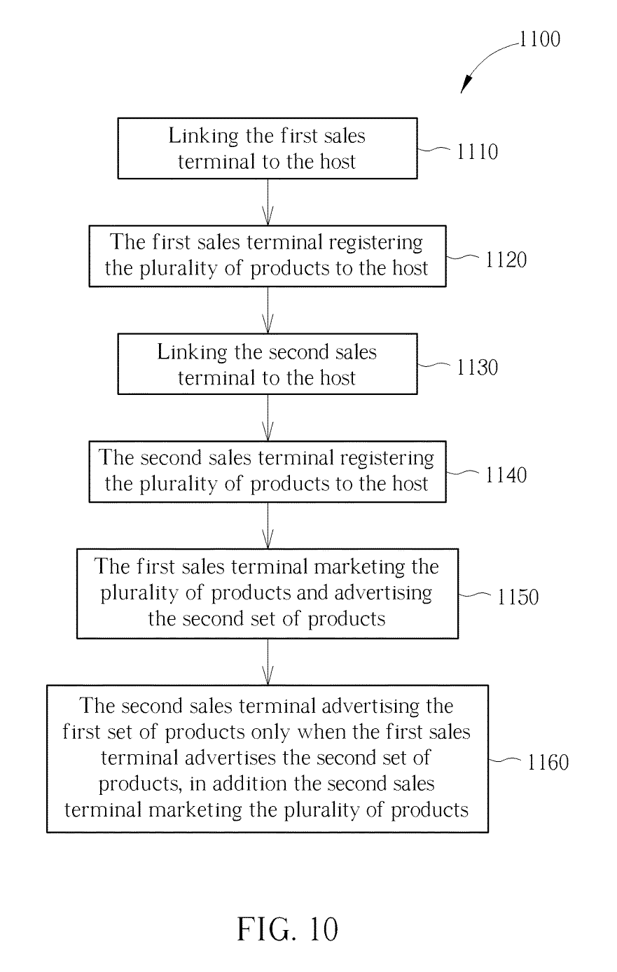

FIG. 10 illustrates a flowchart of a marketing method 1100 according to another embodiment of the present invention. With referring to FIGS. 1 and 2, the marketing method 1100 may include following steps:

Step 1110: linking the first sales terminal 1101 to the host 110;
Step 1120: the first sales terminal 1101 registering the plurality of products P11 to P1m₁ to the host 110;
Step 1130: linking the second sales terminal 1102 to the host 110;
Step 1140: the second sales terminal 1102 registering the plurality of products P21 to P2m₂ to the host 110;
Step 1150: the first sales terminal 1101 marketing the plurality of products P11 to P1m₁ and advertising the second set of products P2x to P2y; and
Step 1160: the second sales terminal 1102 advertising the first set of products P1s to P1t only when the first sales terminal 1101 advertises the second set of products P2x to P2y, in addition the second sales terminal 1102 marketing the plurality of products P21 to P2m₂.

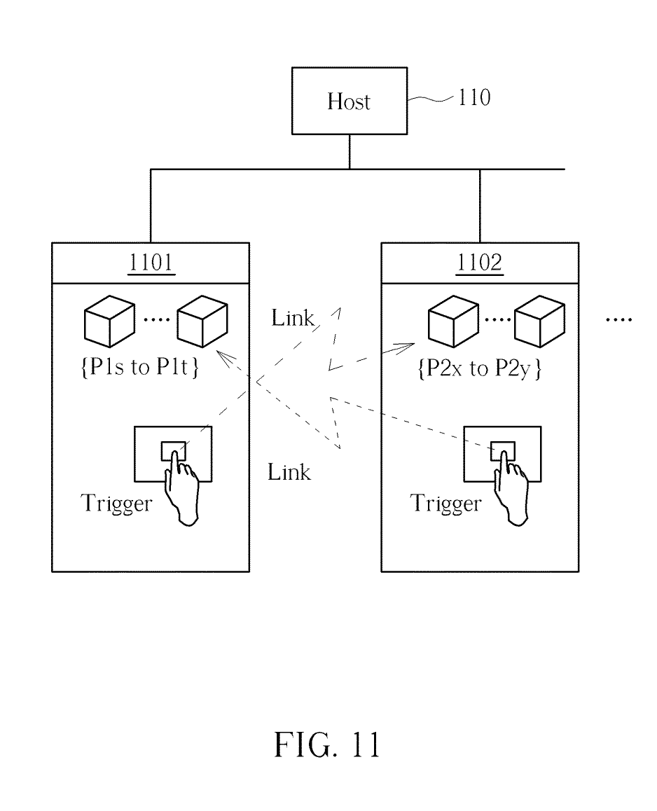

As mentioned above, the first sales terminal 1101 and the second sales terminal 1102 are taken for example to describe the concept of the present embodiment, but more sales terminals are allowed to be included in the marketing system to interact with one another according to embodiments. The marketing method 1100 is similar to the marketing method 500 of FIG. 4. However, different from steps 550 and 560, in steps 1150 and 1160, the first sales terminal 1101 may advertise rather than marketing the second set of products (e.g. P2x to P2y), and the second sales terminal 1102 advertise rather than marketing the first set of products (e.g. P1s to P1t). The verb “advertise” in the text may mean displaying the product information to potential customers. FIG. 11 illustrates a mutual advertising scenario corresponding to the marketing method 1100 of FIG. 11. According to an embodiment, the marketing method may further include hyperlinking an advertisement A2 of the second set of products (e.g. P2x to P2y) advertised by the first sales terminal 1101 to the second sales terminal 1102 after the advertisement A2 is triggered. Hence, the advertisement A2 may be implemented by a physical and/or virtual interface capable of triggering a hyperlink. Likewise, another advertisement A1 advertised by the second sales terminal 1102 may be triggered and hyperlinked to the first sales terminal 1101.

As mentioned above, each of the sales terminals may select categories to be advertised. For example, the first sales terminal 1101 may advertise the second set of products (e.g. P2x to P2y) and the second sales terminal 1102 may advertise the first set of products (e.g. P1s to P1t) only when the second set of products (e.g. P2x to P2y) belongs to a category selected to be advertised by the first sales terminal 1101 and the first set of products (e.g. P1s to P1t) belongs to a category selected to be advertised by the second sales terminal 1102. The mutual advertising operation may be therefore performed and managed by category selection. Similar to the description of FIG. 8, when a transaction is implemented by triggering an advertisement (e.g. A2) at the first sales terminal 1101 to purchase a product (e.g. P22) registered by the second sales terminal 1102, since the transaction is completed with the contributions of the sales terminals 1101 and 1102, the host 110 may allocate a payment to the sales terminals 1101 and 1102 after receiving the payment. A reasonable service charge may be allocated to the host 110 according to an embodiment. The foresaid allocation of the payment should comply with related laws and agreements.

According to an embodiment of the present invention, the marketing system (e.g. 100) may be built and managed by an e-commerce service provider company, and the foresaid sales terminal (e.g. each of the sales terminals 1101 to 110n) may be leased or sold to a manufacturer for the manufacturer to manage. A manufacturer (e.g. a company or an individual) may be very proficient at manufacturing products, but lack marketing skills and marketing channels. Even a manufacturer puts its products onto a large-scale electronic retail website such as e-bay, the products can merely be searched and visited by website users, and it is difficult to perform more active marketing operations. On the other hand, by using the marketing system and method disclosed by an embodiment of the present invention, the foresaid mutual marketing operation and mutual advertising operation may be implemented. Since multiple sales terminals may easily interact with one another, many combinations of products may be marketed and/or advertised on the sales terminals. For each of the sales terminals, the variety of provided products may be increased to even hundred times by simply selecting products for mutual marketing operation, but each sales terminal may still focus mainly on its primary products. Flexible promotion activities and/or pricing strategies may be planned, and potential customers may be developed and shared among manufacturers. The mutual marketing operation of cross-category can also be easily carried on. Hence, the present embodiments can bring significant synergistic marketing effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A marketing system, comprising:
a host;
a first sales terminal linked to the host and configured to register a first set of products to the host and market the first set of products; and
a second sales terminal linked to the host and configured to register a second set of products to the host and market the second set of products;
wherein the second sales terminal markets the first set of products only when the first sales terminal markets the second set of products.

2. The marketing system of claim 1 wherein the host is a server, and the first sales terminal and the second sales terminal are websites.

3. The marketing system of claim 1 wherein customers of products marketed by the first sales terminal or the second sales terminal have sales permits.

4. A marketing method comprising:
linking a first sales terminal to a host;
the first sales terminal registering a first set of products to the host;
linking a second sales terminal to the host;
the second sales terminal registering a second set of products to the host;
the first sales terminal marketing the first set of products and the second set of products; and
the second sales terminal marketing the first set of products only when the first sales terminal markets the second set of products, and marketing the second set of products.

5. The marketing method of claim 4 further comprising:
the first sales terminal pricing the first set of products and the second set of products marketed by the first sales terminal; and
the second sales terminal pricing the first set of products and the second set of products marketed by the second sales terminal.

6. The marketing method of claim 4 further comprising:
selecting categories to be marketed by the first sales terminal in addition to the first set of products;
wherein the second set of products has to belong to a category selected to be marketed by the first sales terminal so as to be marketed by the first sales terminal.

7. The marketing method of claim 4 further comprising:
registering personal data of a customer with the host; and
the customer making a payment to purchase a product marketed by the first sales terminal through the host; and
the host allocating the payment after receiving the payment from the customer.

8. The marketing method of claim 4 further comprising:
the first sales terminal signing a marketing agreement with the host; and
the second sales terminal signing another marketing agreement with the host.

9. The marketing method of claim 4 wherein the second set of products is primary products marketed by the second sales terminal.

10. The marketing method of claim 4 further comprising:
utilizing a shopping cart of the first sales terminal to purchase a product marketed by the first sales terminal; and
utilizing a shopping cart of the second sales terminal to purchase a product marketed by the second sales terminal.

11. The marketing method of claim 4 further comprising:
updating product information of the first set of products and the second set of products at the first sales terminal and the second sales terminal concurrently.

12. The marketing method of claim 4 further comprising:
storing the first set of products in a vicinity of target customers of the first set of products; and
storing the second set of products in a vicinity of target customers of the second set of products.

13. The marketing method of claim 12 wherein the target customers of the first set of products and the target customers of the second set of products have sales permits.

14. A marketing method comprising:
linking a first sales terminal to a host;
the first sales terminal registering a first set of products to the host;
linking a second sales terminal to the host;
the second sales terminal registering a second set of products to the host;
the first sales terminal marketing the first set of products and advertising the second set of products; and
the second sales terminal advertising the first set of products only when the first sales terminal advertises the second set of products, and marketing the second set of products.

15. The marketing method of claim 14 further comprising:
hyperlinking an advertisement of the second set of products advertised by the first sales terminal to the second sales terminal after the advertisement is triggered.

16. The marketing method of claim 14 further comprising:
selecting categories to be advertised by the first sales terminal;
wherein the second set of products has to belong to a category selected to be advertised by the first sales terminal so as to be advertised by the first sales terminal.

17. The marketing method of claim 14 further comprising:
registering personal data of a customer with the host; and
the customer making a payment to purchase a product marketed by the first sales terminal through the host; and
the host allocating the payment after receiving the payment from the customer.

18. The marketing method of claim 14 further comprising:
the first sales terminal signing a marketing agreement with the host; and
the second sales terminal signing another marketing agreement with the host.

19. The marketing method of claim 14 wherein the first set of products is primary products marketed by the first sales terminal, and the second set of products is primary products marketed by the second sales terminal.

20. The marketing method of claim 14 further comprising:
updating product information of the first set of products and the second set of products at the first sales terminal and the second sales terminal concurrently.
